(19) United States
(12) Patent Application Publication
(10) Pub. No.: US 2026/0183653 A1
(43) Pub. Date: Jul. 2, 2026

(54) FORCE FEEDBACK APPARATUS AND ELECTRONIC DEVICE

(71) Applicant: Goertek Inc., Weifang, Shandong (CN)

(72) Inventors: Yueguang Zhu, Shandong (CN); Zhaojiang Liu, Shandong (CN); Yongqiang Wang, Shandong (CN); Zikai Xu, Shandong (CN)

(73) Assignee: Goertek Inc., Weifang, Shandong (CN)

(21) Appl. No.: 18/856,258

(22) PCT Filed: Mar. 31, 2023
(86) PCT No.: PCT/CN2023/085509

§ 371 Date: Oct. 11, 2024

(30) Foreign Application Priority Data
Apr. 11, 2022 (CN) 202210377714.9

(51) Int. Cl. A63F 13/285; A63F 13/24

(52) U.S. Cl. CPC A63F 13/285; A63F 13/24

(57) ABSTRACT

The present disclosure includes a force feedback apparatus and an electronic device. The force feedback apparatus includes a casing, an operation part, and a linear driving assembly. The operation part is slidably provided in the casing along the moving direction of the operation part. The linear driving assembly includes a stator provided fixedly inside the casing and a mover provided slidably inside the casing along a moving direction of the operation part, with the mover connected to the operation part. By providing one of the mover or the stator as an ultra-thin flat coil and the other as a magnetic structure, the flat coil is placed in the magnetic field generated by the magnetic structure, resulting in mutual electromagnetic force feedback between the flat coil and the magnetic structure to the user's finger.

### CROSS-REFERENCE TO RELATED APPLICATIONS

The present disclosure is a National Stage of International Application No. PCT/CN2023/085509 filed on Mar. 31, 2023, which claims priority to a Chinese patent application No. 202210377714.9 filed with the China National Intellectual Property Administration on Apr. 11, 2022, both of which are hereby incorporated by reference in their entireties.

### TECHNICAL FIELD

The present disclosure relates to the field of gaming devices, particularly involving force feedback apparatuses and electronic devices.

### BACKGROUND

Currently, to enhance user experience, household gaming devices have designed force feedback apparatuses on game controllers (including traditional game controllers and new AR/VR handheld controllers, etc.), adding various force feedback modes to achieve interaction between game content and players, simulating realistic force feedback effects.

However, the existing force feedback solutions use traditional compression springs and ordinary mover motors to drive gearboxes to cooperate so as to achieve rotational force feedback effects, the single body of which occupy significant space, have complex module structures, and are difficult to miniaturize.

### SUMMARY

The major objective of the present disclosure is to propose a force feedback apparatus and an electronic device, aimed at solving the problem that single bodies of existing force feedback apparatuses occupying large spaces and being difficult to miniaturize.

To achieve the above objectives, the present disclosure proposes a force feedback apparatus, wherein the force feedback apparatus includes:
a casing;
an operation part, movably provided in the casing;
a fixed part; and
a linear driving assembly, comprising a stator fixedly provided inside the casing and a mover movably provided inside the casing along the moving direction of the operation part, wherein the mover is fixed to the fixed part, the fixed part is connected to the operation part, wherein one of the stator and the mover is a flat coil, and the other is a magnetic structure, the magnetic structure forms a magnetic field, and the flat coil is located within the magnetic field.

Optionally, the magnetic structure includes a magnet group, the magnet group comprising two magnets, the two magnets forming a magnetic gap therebetween, the flat coil provided in the magnetic gap; and
the stator comprising the magnetic structure, and the mover comprising the flat coil.

Optionally, there are provided at least two magnet groups, the two magnet groups arranged in the moving direction, magnets located on the same side of the magnetic gaps of the two magnet groups having opposite magnetization directions, so that the magnetic gaps corresponding to the two magnet groups have opposite magnetic field directions; and
two edges of the flat coil oppositely provided in the moving direction of the operation part are respectively located in the magnetic gaps corresponding to the two magnet groups.

Optionally, the casing comprising multiple side parts, the multiple side parts enclosing an installation channel extending along the moving direction of the operation part, the multiple side parts comprising a first side part and a second side part that are oppositely provided, the operation part slidably provided in the installation channel along the moving direction of the operation part; and
the magnetic structure and the flat coil are layered between the first side part and the second side part.

Optionally, the force feedback apparatus further includes an installation frame, the installation frame slidably provided in the installation channel along the moving direction of the operation part so as to have a first end exposed outside the installation channel and a second end located inside the installation channel, the first end connected to the operation part, the second end forming an installation groove configured to accommodate the mover.

Optionally, the installation groove is an annular groove, and the flat coil is held in the annular groove

Optionally, the casing includes a yoke arranged corresponding to the magnetic structure.

Optionally, the force feedback apparatus further includes a controller, a displacement sensor, and a power supply module, the displacement sensor configured to detect a displacement signal of the operation part, the controller electrically connected to the displacement sensor and the power supply module, to control a current magnitude and a current direction of the power supply module according to the displacement signal.

Optionally, the force feedback apparatus further includes a restoration member, configured to act together with the mover on the operation part when the operation part is in motion.

The present disclosure further provides an electronic device which comprises the force feedback apparatus as described above; the force feedback apparatus includes:
a casing;
an operation part, slidably provided in the casing along a moving direction of the operation part;
an elastic member, one end of which is connected to the operation part, and the other end of which is connected to the casing; and
a linear driving assembly, comprising a stator fixedly provided inside the casing and a mover slidably provided inside the casing along the moving direction of the operation part, wherein the mover is connected to the operation part, the fixed part is connected to the operation part, wherein one of the stator and the mover is a flat coil, and the other is a magnetic structure, the magnetic structure forms a magnetic field, and the flat coil is located within the magnetic field.

Optionally, the electronic device includes a game operation apparatus or a mobile terminal device.

In the technical solution provided by the present disclosure, when the user's finger needs to press the operation part, the elastic force generated by the elastic member is fed back to the user's finger and provides a restoration force for the operation part. During the operating process of pressing the operation part, the feedback force of the elastic member is related to the deformation of the elastic member. When the virtual feedback force needs to be simulated has no direct relationship with the movement travel of the operation part, by arranging one of the mover and the stator as a flat coil and the other as a magnetic structure, the flat coil is located within the magnetic field generated by the magnetic structure. When the flat coil is energized, an interactional electromagnetic force is produced between the flat coil and the magnetic structure, which is then fed back to the mover. This force, together with the elastic force generated by the elastic member, forms a resultant force that is fed back to the user's finger. Additionally, the flat coil is flatly arranged, allowing the overall structure of the linear driving assembly to achieve a flat and miniaturized ultra-thin design while meeting the requirements for force feedback effects. This design is suitable for the application needs of different types of handles, thereby solving the problem of single bodies of existing force feedback apparatuses occupying large spaces and being difficult to miniaturize.

### BRIEF DESCRIPTION OF THE DRAWINGS

To more clearly illustrate the technical solutions of the embodiments of the present disclosure or the prior art, the following is a brief introduction to the drawings used in the description of the embodiments or the prior art. It should be obvious that the drawings described below are merely some embodiments of the present disclosure. For those of ordinary skill in the art, other drawings can be obtained based on these drawings without exerting any creative effort.

FIG. 1 is an exploded view of an embodiment of the force feedback apparatus provided by the present disclosure.

FIG. 2 is a plan view of the force feedback apparatus shown in FIG. 1.

FIG. 3 is a sectional view along line A-A of the apparatus shown in FIG. 2.

List of Reference Signs:

| Reference | | Reference | |
|---|---|---|---|
| Number | Name | Number | Name |
| 100 | Force feedback apparatus | 41 | Stator |
| 1 | Casing | 41a | Magnet group |
| 11 | First side part | 411 | Magnet |
| 12 | Second side part | 42 | Mover |
| 2 | Operation part | 421 | Flat coil |
| 3 | Elastic member | 5 | Installation frame |
| 4 | Linear driving assembly | 51 | Installation groove |

The realization of the objectives, functional features, and advantages of the present disclosure will be further explained in conjunction with the embodiments and with reference to the drawings.

### DETAILED DESCRIPTION

Provided hereinbelow is a clear and complete description of the technical solutions of the embodiments of the present disclosure in conjunction with the drawings of the embodiments. Obviously, the described embodiments are only part of, rather than all of, the embodiments of the present disclosure. Based on the embodiments of the present disclosure, all other embodiments obtained by those of ordinary skill in the art without making any creative effort shall fall within the scope of protection of the present disclosure.

It should be noted that if there are directional indications (such as up, down, left, right, front, rear, etc.) involved in the embodiments of the present disclosure, these directional indications are only used to explain the relative positional relationships and motion conditions of the components under a specific posture (as shown in the drawings). If the specific posture changes, the directional indications also change accordingly.

Additionally, if there are descriptions involving “first,” “second,” etc., in the embodiments of the present disclosure, these terms are used only for descriptive purposes and should not be understood as indicating or implying their relative importance or implicitly indicating the number of the indicated technical features. Therefore, features designated as “first” or “second” may explicitly or implicitly include at least one such feature. Furthermore, the term “and/or” appearing throughout the text includes three parallel schemes; for example, “A and/or B” includes solution A, solution B, or a solution where both A and B are satisfied simultaneously. Additionally, the technical solutions of various embodiments can be combined, but this must be based on what can be realized by those of ordinary skill in the art. When a combination of technical solutions leads to mutual contradictions or cannot be realized, such combinations shall be deemed not to exist and are not within the scope of protection claimed by the present disclosure.

Currently, to enhance user experience, household gaming devices have designed force feedback apparatuses on game controllers (including traditional game controllers and new AR/VR handheld controllers, etc.), adding various force feedback modes to achieve interaction between game content and players, simulating realistic force feedback effects. However, the existing force feedback solutions use traditional compression springs and ordinary mover motors to drive gearboxes to cooperate so as to achieve rotational force feedback effects, the single body of which occupy significant space, have complex module structures, and are difficult to miniaturize.

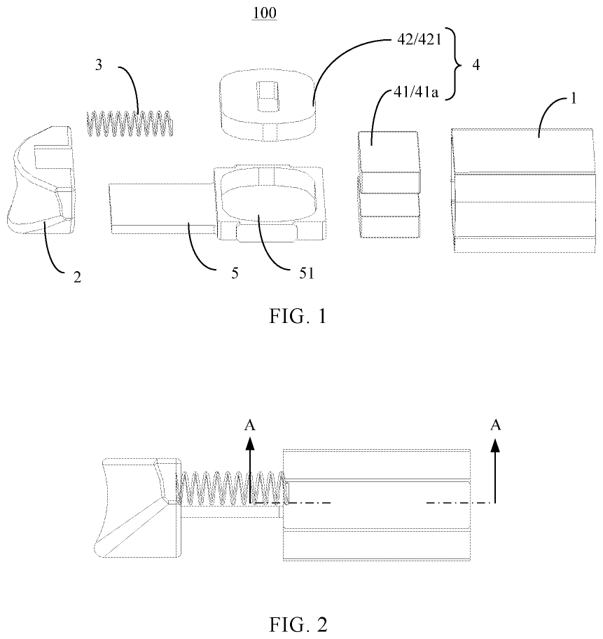

To solve the aforementioned problems, the present disclosure provides a force feedback apparatus 100. FIG. 1 to FIG. 3 show specific embodiments of the force feedback apparatus 100 provided by the present disclosure.

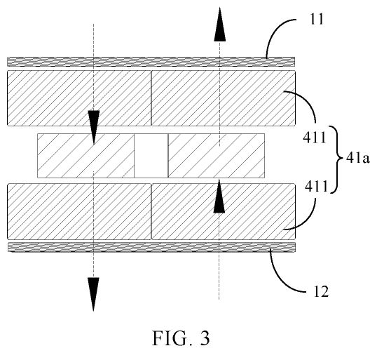

Please refer to FIG. 1 to FIG. 2. The force feedback apparatus 100 includes a casing 1, an operation part, and a linear driving assembly 4: the operation part 2 is movably provided in the casing 1; a fixed part (not shown); the linear driving assembly 4 includes a stator 41 that is fixedly arranged within the casing 1, and a mover 42 that slidably provided within the casing 1 along the moving direction of the operation part. The mover 42 is fixed to the fixed part, which is connected to the operation part 2. Among these, one of the stator 41 and the mover 42 is a flat coil 421, and the other is a magnetic structure. The magnetic structure forms a magnetic field, and the flat coil 421 is situated within this magnetic field.

In the technical solution provided by the present disclosure, when the user's finger needs to press the operation part, and when the virtual feedback force needs to be simulated has no direct linear relationship with the movement travel of the operation part, this can be achieved by arranging one of the mover 42 and the stator 41 as a flat coil 421 and the other as a magnetic structure. The flat coil 421 is located within the magnetic field generated by the magnetic structure. When the flat coil 421 is energized, an interactional Ampère force is produced between the flat coil 421 and the magnetic structure, which is then fed back to the mover 42. Additionally, the flat coil 421 is flatly arranged, allowing the overall structure of the linear driving assembly 4 to achieve a flat and miniaturized ultra-thin design while meeting the requirements for force feedback effects. This design is suitable for the application needs of different types of handles, thereby solving the problem of single bodies of existing force feedback apparatuses occupying large spaces and being difficult to miniaturize.

Furthermore, the force feedback apparatus also includes a restoration member that, during moving of the operation part, together with the mover, acts on the operation part. The restoration member can be an elastic member 3, which provides elastic force feedback to the user's finger and supplies the restoration force for the operation part 2. During the process of pressing the operation part 2, the feedback force from the elastic member 3 is related to its deformation. At this time, the resultant force formed by the elastic force from the elastic member 3 and the Ampère force is fed back to the user's finger.

Specifically, please refer to FIG. 3. In this embodiment, the magnet structure includes a magnet group 41a, which comprises two magnets, forming a magnetic gap between them. The flat coil 421 is arranged within this magnetic gap. The stator 41 includes the two magnets 411, and the mover 42 includes the flat coil 421. When the flat coil 421 is energized with an alternating current, a part of the flat coil 421 located in the magnetic gap will generate an Ampère force. In particular, according to the left-hand rule, you can determine the direction of the Ampère force (i.e., the direction of the force on the conductor): extend your left hand so that the thumb is perpendicular to the other four fingers and all lie in the same plane; let the magnetic field lines enter through the palm of your hand, point the four fingers in the direction of the current, and the direction the thumb points is the direction of the Ampère force. Thus, the direction of the force acting on the flat coil 421 in the magnetic field can be determined. When it is necessary to increase the sense of resistance in the feedback force, the direction of the current within the flat coil 421 can be determined so that the Ampère force it generates points towards the user's finger. Conversely, when a sense of release is needed, the direction of the current within the flat coil 421 can be set such that the Ampère force it generates is opposite to the direction of the user's finger.

It should be noted that since the Ampère force is a force generated by the interaction between the magnets and the current-carrying conductor, it can be understood that, referring to FIG. 3, the stator 41 may include two magnets 411, and the mover 42 includes the flat coil 421. When the two magnets 411 are fixed to the casing 1, the flat coil 421 is driven by the Ampère force. Of course, when the flat coil 421 is fixed to the casing 1, the Ampère force acts on the two magnets 411. In this case, the flat coil 421 can be considered as the stator 41, and the two magnets 411 can be regarded as the mover 42.

Furthermore, because the current directions of the two segments of wire in the cross-section of the flat coil 421 are set to be opposite, in order to achieve a larger value range of feedback force values for better user experience, in this embodiment, there are provided at least two magnet groups 41a. The two magnet groups 41a are arranged along the moving direction of the operation part. The polarities of the magnets on the same side of the magnetic gaps in the two magnet groups 41a are set to be opposite, thus making the magnetic field directions in the magnetic gaps corresponding to these two magnet groups 41a opposite to each other. Two edges of the flat coil 421 oppositely provided in the moving direction of the operation part are respectively positioned within the magnetic gaps corresponding to these two magnet groups 41a. This arrangement ensures that both oppositely provided edges of the flat coil 421 can simultaneously experience Ampère forces in the same direction, doubling the theoretical value of the feedback force. Of course, apart from providing more magnet groups 41a and flat coils 421, the magnitude of the feedback force can also be adjusted by changing the current value in the flat coil 421. The greater the current value, the larger the Ampère force, and conversely, the smaller the current value, the smaller the Ampère force.”

Specifically, in order to match the flattened and ultra-thin design of the flat coil 421, please refer to FIG. 3. In this embodiment, the casing 1 includes multiple side parts that enclose an installation channel extending along the moving direction of the operation part. Preferably, the cross-sectional shape of the installation channel is rectangular. The multiple side parts include a first side part 11 and a second side part 12 that are oppositely arranged. The operation part 2 is slidably provided in the installation channel along the direction of its movement. The magnet structure and the flat coil 421 are layered between the first side part 11 and the second side part 12, making the force feedback apparatus 100 compact in the thickness direction, suitable for various types of handle triggers.

Specifically, in this embodiment, the force feedback apparatus 100 also includes an installation frame that is slidably provided in the installation channel along the moving direction of the operation part, having a first end exposed outside the installation channel and a second end located inside the installation channel. The first end is connected to the operation part 2. By providing the installation frame, the operation part 2 can achieve a greater movement travel along its moving direction, enhancing the user's operational experience. Additionally, there is an installation groove 51 formed at the second end, which is used to accommodate the flat coil 421. When the flat coil 421 is driven by the Ampère force, it applies a force to the sidewalls of the installation groove 51, thereby achieving feedback of magnetic force driving for the operation part 2.

Further, to achieve maximum thinness, in this embodiment, the installation groove 51 is an annular groove. The flat coil 421 is held within the annular groove, with the circumferential wall of the annular groove holding the circumferential sides of the flat coil 421. Under the condition of ensuring the strength of the installation frame, the annular groove can be provided to have the same height dimensions as the flat coil 421, or even smaller dimensions, to achieve flattening.

Due to the magnetic field generated by the magnet structure, in order to maximize the efficiency of the magnetic field action on the flat coil 421, in this embodiment, the casing 1 includes a magnetic yoke corresponding to the magnet structure. Because the magnetic yoke has a high magnetic permeability, it can constrain the magnetic field, allowing the magnetic field of the magnet structure to function with greater efficiency.

In this embodiment, the force feedback apparatus 100 also includes a controller, a displacement sensor, and a power supply module. The power supply module is used to provide currents with different magnitudes and directions to the flat coil 421. The displacement sensor is used to detect the displacement signal of the operation part 2. The controller is electrically connected to the displacement sensor and the power supply module, to control the magnitude and direction of the current from the power supply module based on the displacement signal.

In practical applications, during game use, when the user pulls the trigger and presses the operation part 2 for game operation-taking a racing game as an example—when the car is stationary within the game, no current is generated from the game information. At this time, when the user presses the operation part 2, the feedback force felt is the restoration elastic force produced by the elastic member 3. When the car is moving, the resistance in the game scenario is relatively small; the current provided by the power supply module is a negative current. This negative current passes through the flat coil 421 and produces an Ampère force opposite to the aforementioned repulsive force. The feedback force felt by the user is the resultant force of the restoration elastic force minus the Ampère force, meaning the user feels a smaller game feedback force, making it relatively easy to initiate movement. Similarly, when the car collides with an obstacle, the current provided by the power supply module is a positive current, with the Ampère force direction the same as the restoration elastic force direction. Therefore, the game feedback force felt by the user is the sum of the restoration elastic force and the Ampère force, corresponding to a larger feedback force in the game content, making it harder to initiate movement.

The present disclosure also provides an electronic device, which can be a game controller, a game console, a game operation device, or a mobile terminal device, etc. This electronic device includes the force feedback apparatus 100. The specific structure of the force feedback apparatus 100 refers to the aforementioned embodiment. Since this electronic device adopts all the technical solutions of the above embodiments, it therefore possesses all the advantageous effects brought about by all the technical solutions of the above embodiments, which will not be elaborated here.

The foregoing describes only preferred embodiments of the present disclosure and is not intended to limit the scope of the patent of the present disclosure. Any equivalent structural changes made under the inventive concept of the present disclosure, using the contents of the description and drawings of the present disclosure, or directly/indirectly applied in other related technical fields, shall be included within the scope of protection of the patent of the present disclosure.

1. A force feedback apparatus, comprising:
a casing;
an operation part, movably provided in the casing;
a fixed part; and
a linear driving assembly, comprising a stator fixedly provided inside the casing and a mover movably provided inside the casing along a moving direction of the operation part, wherein the mover is fixed to the fixed part, the fixed part is connected to the operation part, wherein a first of the stator and the mover comprises a flat coil, and a second of the stator and the mover comprises a magnetic structure, the magnetic structure is adapted to generate a magnetic field with the flat coil located therewithin.

2. The force feedback apparatus according to claim 1, wherein:
the stator comprising the magnetic structure, and the mover comprising the flat coil; and
the magnetic structure comprising a magnet group, the magnet group comprising two magnets with a magnetic gap formed therebetween, and the flat coil provided in the magnetic gap.

3. The force feedback apparatus according to claim 2, wherein:
there are at least two magnet groups, each comprising two magnets with a magnetic gap formed therebetween arranged in the moving direction, wherein magnets located on the same side of the magnetic gaps of the two magnet groups having opposite magnetization directions, so that the magnetic gaps corresponding to the two magnet groups have opposite magnetic field directions; and
two edges of the flat coil oppositely provided in the moving direction of the operation part are respectively located in the magnetic gaps corresponding to the two magnet groups.

4. The force feedback apparatus according to claim 1, wherein:
the casing comprising multiple side parts, the multiple side parts enclosing an installation channel extending along the moving direction of the operation part, the multiple side parts comprising a first side part and a second side part that are oppositely provided, the operation part slidably provided in the installation channel along the moving direction of the operation part; and
the magnetic structure and the flat coil are layered between the first side part and the second side part.

5. The force feedback apparatus according to claim 4, further comprising an installation frame, the installation frame slidably provided in the installation channel along the moving direction of the operation part so as to have a first end outside the installation channel and a second end inside the installation channel, the first end connected to the operation part, and the second end having an installation groove configured to accommodate the mover.

6. The force feedback apparatus according to claim 5, wherein:
the installation groove comprises an annular groove, with the flat coil held therein.

7. The force feedback apparatus according to claim 1, wherein:
the casing comprises a yoke corresponding to the magnetic structure.

8. The force feedback apparatus according to claim 1, further comprising a controller, a displacement sensor, and a power supply module, the displacement sensor configured to detect a displacement signal of the operation part, the controller electrically connected to the displacement sensor and the power supply module, to control a current magnitude and a current direction of the power supply module according to the displacement signal.

9. The force feedback apparatus according to claim 1, further comprising a restoration member, configured to act together with the mover on the operation part when the operation part is in motion.

10. An electronic device, comprising:
a force feedback apparatus according to claim 1.
